(19) United States
(12) Patent Application Publication
(10) Pub. No.: US 2025/0053857 A1
(43) Pub. Date: Feb. 13, 2025

(54) ARTIFICIAL INTELLIGENCE MODEL THAT ACTS AS USER INTERMEDIARY TO EXTERNAL ARTIFICIAL INTELLIGENCE MODEL API

(71) Applicant: Auddia Inc., Boulder, CO (US)

(72) Inventors: Jeffrey Thramann, Boulder, CO (US); Michael Lawless, Boulder, CO (US); Pablo Calderon Rodriguez, Boulder, CO (US)

(21) Appl. No.: 18/444,235

(22) Filed: Feb. 16, 2024

Related U.S. Application Data
(60) Provisional application No. 63/486,191, filed on Feb. 21, 2023.

(51) Int. Cl. G06N 20/00

(52) U.S. Cl. CPC G06N 20/00

(57) ABSTRACT

A method and system for providing an intermediary AI model that interfaces with a general purpose generative AI engine (e.g., a chatbot) that improves interface with the general-purpose AI in a domain-specific environment. The intermediary AI makes use of user specific information, user preferences, domain-specific concerns, trends, and makes use of a feedback loop to improve the operation thereof.

### CROSS-REFERENCE TO RELATED APPLICATION(S)

This application claims the benefit of U.S. Provisional Patent Application No. 63/486,191, filed Feb. 21, 2023, which is incorporated by reference herein in its entirety.

### TECHNICAL FIELD

The disclosure relates to software interaction between multiple artificial intelligence (AI) models and more specifically to intermediary human-AI facilitation.

### BACKGROUND

A recent trend in AI is to make use of general-purpose generative AI applications. An example of such an application is the ChatGPT family of OpenAI models. These sorts of models make use of a natural language chat interface for humans to make requests upon the AI. At the time of filing, general-purpose generative AI's first attempt at responding to a user's queries is middling and requires query refinement from the user. Over the course of a given chat session the user refines their queries, and the general-purpose model provides a better response.

### BRIEF DESCRIPTION OF THE DRAWINGS

FIG. 1 is a flowchart illustrating a method of operating an intermediary AI with a general-purpose generative AI.

FIG. 2 is a block diagram of a mixed AI system.

FIG. 3 is a block diagram illustrating an example computer system, in accordance with one or more embodiments.

FIG. 4 is a block diagram illustrating an example ML system, in accordance with one or more embodiments.

### DETAILED DESCRIPTION

Disclosed herein is a domain-specific intermediary AI model that interacts with a general-purpose generative AI to improve the pace of effective human interaction with the general-purpose model. A given example of a domain for which the intermediary AI operates is the generation of media playlists. The intermediary AI takes a query from a given user and refines the query for the user prior to submitting that query to the general-purpose generative AI.

The intermediary AI does not need extreme training in order to produce complex results, but rather merely trains on a domain-specific area and on the narrow area of query revision within that domain. The intermediary AI further makes use of user-specific data as opposed to a general-purpose AI which operates the same for all users. The user-specific data remains privately held with the platform upon which the intermediary resides and is not directly shared with the general-purpose generative AI.

The intermediary AI further enables direct application of general-purpose AI output to particular ends. For example, where the domain the intermediary AI operates in is media playlist generation, once a playlist is obtained, the intermediary AI applies that playlist to a media player. Thus, the intermediary AI simplifies the user interface for the user and improves intuitiveness.

In a given example, a user prepares the natural language query, “generate a 5-hour classic rock mix.” The intermediary AI takes that query, and revises it to, “generate a 5-hour classic rock mix without repeated songs and using songs with an average of over 110 beats per minute and do not include any songs by Tom Petty.” The intermediary AI makes use of awareness of domain-specific faults in the general-purpose AI's operation, e.g., the propensity to repeat songs, and makes use of user-specific information such as the preference to avoid Tom Petty and play relatively fast songs.

The example of a single general-purpose AI has been used for simplicity. In some embodiments, the intermediary AI operates as an intermediary for multiple general-purpose AIs and submits queries to each of a plurality of general-purpose AI models and compares the results. The results from each general-purpose AI are combined or weighted based on training of the intermediary AI.

A specific example of the general-purpose AI is ChatGPT. Standard ChatGPT prompts go into ChatGPT and produce an output. Through use of intermediary AI models, both the prompt and output are used as data to train the intermediary AI models by using the feedback loop to rate the result. refined/improved ChatGPT prompts go into ChatGPT and produce a modified output—both the modified prompt and modified output are used as data to train the intermediary AI and a NewGPT by using the feedback loop to rate the modified result against the original result.

Once the intermediary AI is trained with enough data, then the modified/improved prompts are entered into both ChatGPT and the NewGPT and the feedback loop determines the better result. This feedback data is entered into the intermediary AI to train it to know the better result. ChatGPT is not trained with this data. As a result, ultimately NewGPT becomes smarter than ChatGPT for the domain specific subject matter.

There are two resultant machine learning (AI) models. One is a language model that improves prompts and conversations. The other is a substitute GPT that gets better than ChatGPT for domain specific purposes over time, i.e., with more use and therefore more training data. Ultimately, an end result is to replace or augment the ChatGPT because NewGPT is consistently delivering the better results.

Above, a single example of a media playlist is provided that refers to songs. Other examples of media playlists include blogs, vlogs, TED talks, real crime stories, sporting event radio or television broadcasts, Internet streaming videos, recorded investment advice, or other suitable forms of consumable media. Further, while the specific example of “media playlist generation” is provided, the disclosure herein can further apply to other forms of query refinement. Example of other forms of query refinement include job-seeking searches, tax advice, and how-to guides.

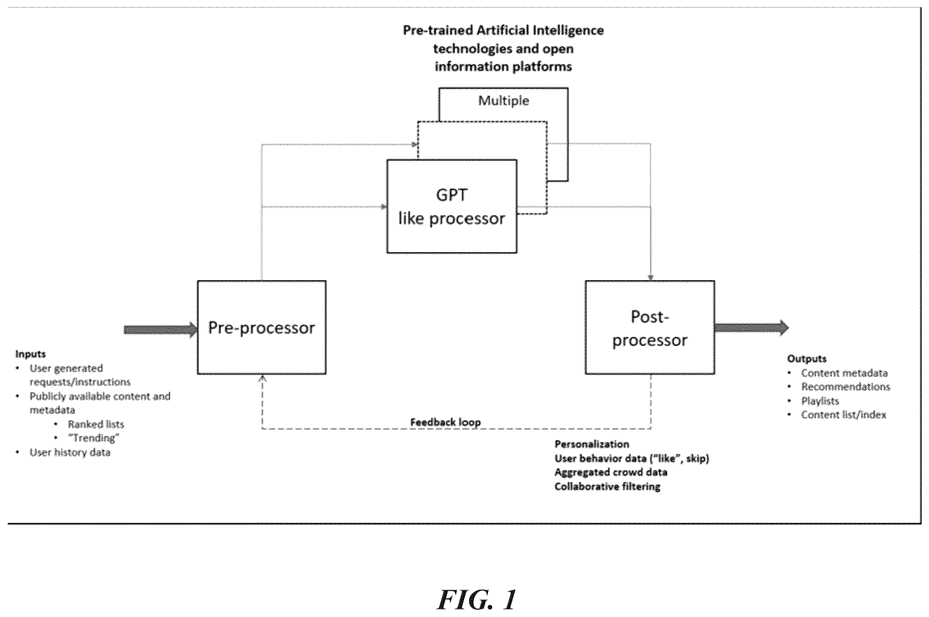

FIG. 1 is a block diagram of a mixed AI system. A pre-processor and a post processor element are arranged to communicate with one or more general-purpose generative AIs. The pre- and post-processors are implemented as AI models either separate or interrelated. The AI model(s) of the pre- and post-processor are domain-specific models. In this case, the domain to which the pre- and post-processor are directed to is query refinement. In some embodiments, the specificity of the domain is increased to areas such as query refinement of playlist generation queries.

A general-purpose generative AI is an AI engine that generates human language answers to queries (e.g., a question-answer engine). OpenAI has developed a series of ChatGPT models. GPT in ChatGPT stands for generative pre-trained transformers. GPT framework is just one way to accomplish a “chatbot” functionality. The ChatGPT series of models is a single example of a broader category of general-purpose AI. Other examples include: Web-crawlers based search engines (e.g. Google search), Database Queries (e.g. indexed catalog queries or SQL queries), and Pre-stored question-answer catalogs.

The pre-processor and post-processor work together as intermediaries between a user and a general-purpose AI. The pre- and post-processor engage with the general-purpose AI either via an API of the general-purpose AI, or alternatively have a human-simulator interface that enables the pre- and post-processor to programmatically engage with the general-purpose AI in the same manner a human would.

In operation the pre-processor provides input to the general-purpose AI and the post-processor receives the output of the general-purpose AI. The input is tailored by the pre-processor, and the output is revised and implemented as a feedback loop by the post-processor. Input tailoring is enabled by any combination of domain-specific training, user-specific preferences and history, publicly available trending data. Revisions by the post-processor assist in enforcing the intended result of the input tailoring.

The post-processor further enables delivery to subsequent platforms. General-purpose AI typically provide a text-based output that is intended for human consumption, but the post-processor can directly hand that output off to another platform that makes immediate use of the output. For example, where the output is a playlist or a media request, the output is directly handed off to a media player that searches up the relevant media and plays it.

In some embodiments, the pre- and post-processor integrate with multiple general-purpose AI models. Because the pre- and post-processor continue to learn from experiences via feedback loops, the pre- and post-processor determines over time the best general-purpose AIs within the integrated platform for particular queries or sub-queries. The output from each of the general-purpose AI models is compared against one another to identify to best response as understood by the training of the pre- and post-processors. Similarly so, the pre-processor refines queries to each general-purpose model individually and tailored to the particular general-purpose AI as most effective for that general-purpose AI.

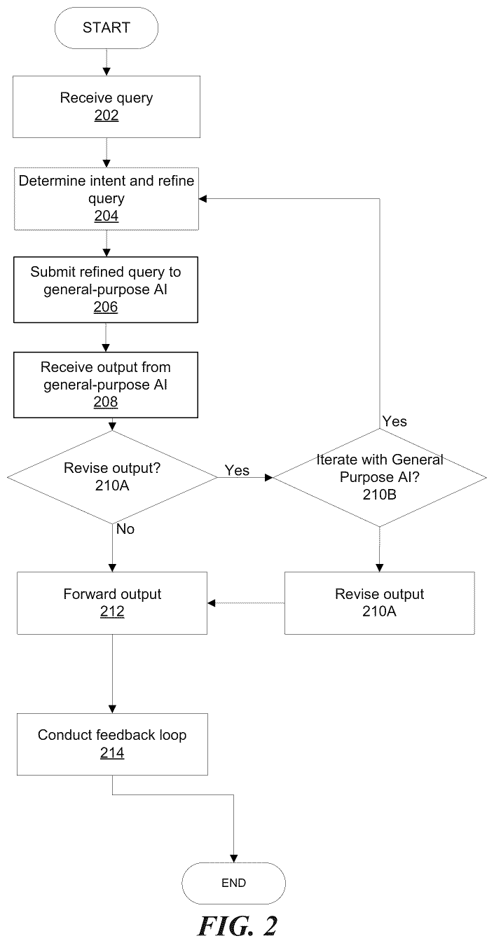

FIG. 2 is a flowchart illustrating a method of operating an intermediary AI with a general-purpose generative AI. In step 202, in the example of a media player integrated system, a user interacts with a pre-processor by providing a query, such as a request for the generation of a playlist. The query is phrased in a human language such as “generate a 5-hour classic rock mix.” The phrase provided is merely an example, and neigh-infinite other queries could feasibly be received.

In step 204, the pre-processor determines an intent of the query based on the domain-specific aims of the pre-processor and revises the query. The “domain” referred to is query refinement. The refinement of the query sought is to elicit an optimal response from the general-purpose AI via minimal interactions. Refinements add specificity to the query or rephrase the language used into language that results in a more effective question/answer session with the general-purpose AI(s). The training for the refinement is based on a feedback loop of domain-specific interactions with the general-purpose AI(s) as well as user-specific information. In some embodiments, users hold user accounts with the pre- and post-processor. The user accounts enable the application of user-specific information (e.g., preferences) to be applied to a query with the general-purpose AI without the user actively having to express that preference. The intermediary model uses historical requests, publicly available data and user data among other inputs to refine the initial request. And the feedback loop would also allow us to take previous transaction results and use those as inputs to the pre-processor.

Given the sample query above, “generate a 5-hour classic rock mix,” a given refinement may be to shift the query to, “generate a 5-hour classic rock mix without repeated songs and using songs with an average of over 110 beats per minute and do not include any songs by Tom Petty.” The intermediary AI makes use of awareness of domain-specific faults in the general-purpose AI's operation, e.g., the propensity to repeat songs, and makes use of user-specific information such as the preference to avoid Tom Petty and play relatively fast songs.

In another example, the initial query is “generate a 12-song playlist like Elton John.” That query is revised into “Name 10 recording artists who are similar to Elton John and create a 12-song playlist of songs from these artists.” Had the user simply posed the first query to the general-purpose model, that model would like return 12 Elton John songs. Conversely, the refined query changes the query into a two-part query that the general-purpose model will answer in stages rather than attempt to answer a single query. The general-purpose model will first identify 10 artists that fit the query, then create a playlist from those. In post-processing, the first part of that output (the list of artists) is removed, and only the 12-song playlist of artists “like” Elton John remains.

In step 206, the pre-processor outputs a refined query to a one or more general-purpose AI models that receive text queries. For purposes of this disclosure the general-purpose AIs produce a response to queries. The operation of how those models generate the response is beyond the scope of this disclosure. These models operate as a “black box” that generate output from input.

In step 208, the post-processor receives output from the general-purpose AI(s) and evaluates the output. In step 210, the post-processor revises the output (A) or provides feedback to the pre-processor for purposes to injecting revised input into the general-purpose AI(s) (B). Step 210 does not necessarily occur every time. Where the output produced by the general-purpose AI is evaluated as sufficient, further revision is unnecessary. Where the output is insufficient, revision occurs. In step 212, the output is forwarded by the post-processor to an output handler, such as a media platform, that renders a result on the output (e.g., calling up requested media and playing it).

In step 214, the post-processor provides feedback to the domain-specific model. Some embodiments of the feedback used in the feedback loop include direct user input, or passive user use analytics that illustrate value of output. In some embodiments, the feedback loop the domain-specific model grades its own output and learns therefrom.

### Computing Platform

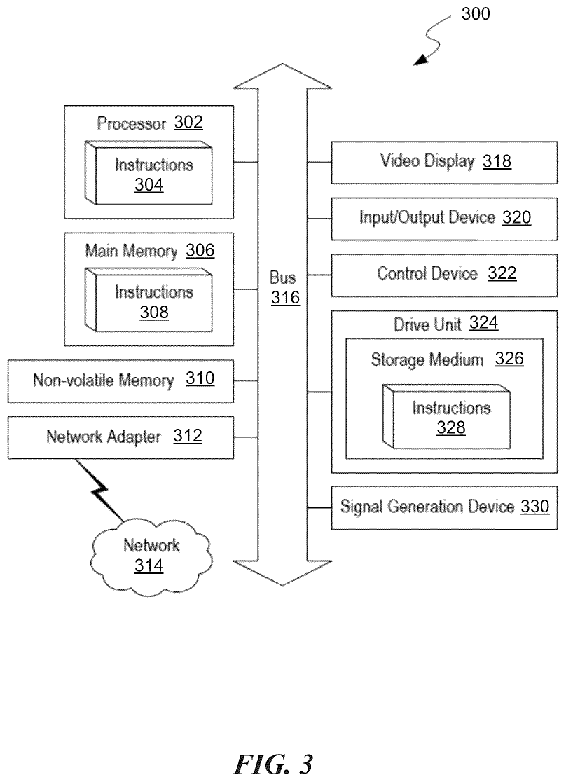

FIG. 3 is a block diagram illustrating an example computer system 300, in accordance with one or more embodiments. In some embodiments, components of the example computer system 300 are used to implement the software platforms described herein. At least some operations described herein can be implemented on the computer system 300.

The computer system 300 can include one or more central processing units (“processors”) 302, main memory 306, non-volatile memory 310, network adapters 312 (e.g., network interface), video displays 318, input/output devices 320, control devices 322 (e.g., keyboard and pointing devices), drive units 324 including a storage medium 326, and a signal generation device 320 that are communicatively connected to a bus 316. The bus 316 is illustrated as an abstraction that represents one or more physical buses and/or point-to-point connections that are connected by appropriate bridges, adapters, or controllers. The bus 316, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The computer system 300 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 300.

While the main memory 306, non-volatile memory 310, and storage medium 326 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 328. The term “machine-readable medium” and “storage medium” shall also be taken to include any medium that is capable of storing, encoding, or carrying a set of instructions for execution by the computer system 300. In some embodiments, the non-volatile memory 310 or the storage medium 326 is a non-transitory, computer-readable storage medium storing computer instructions, which can be executed by the one or more central processing units (“processors”) 302 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 304, 308, 328) set at various times in various memory and storage devices in a computer device. When read and executed by the one or more processors 302, the instruction(s) cause the computer system 300 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 310, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 312 enables the computer system 300 to mediate data in a network 314 with an entity that is external to the computer system 300 through any communication protocol supported by the computer system 300 and the external entity. The network adapter 312 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 312 can include a firewall that governs and/or manages permission to access proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

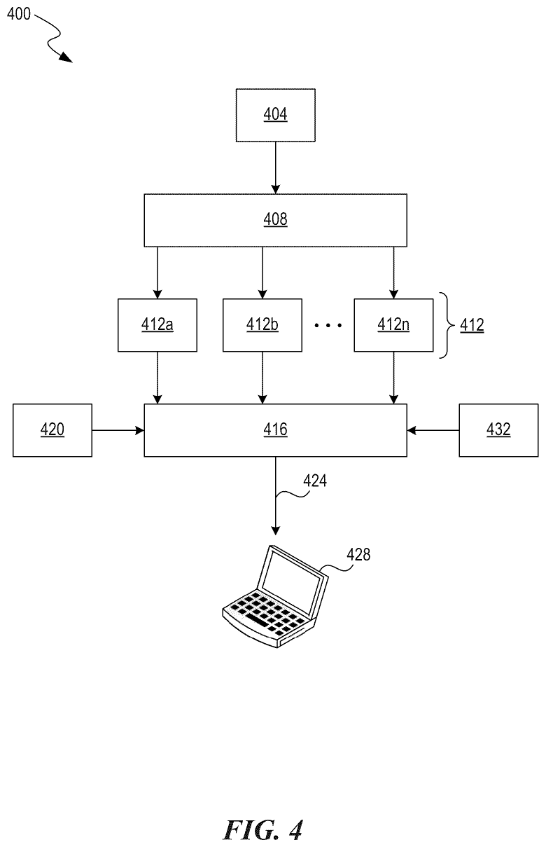

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 400 illustrated and described in more detail with reference to FIG. 4.

### Machine Learning System

FIG. 4 is a block diagram illustrating an example ML system 400, in accordance with one or more embodiments. The ML system 400 is implemented using components of the example computer system 400 illustrated and described in more detail with reference to FIG. 3. Likewise, embodiments of the ML system 400 can include different and/or additional components or be connected in different ways. The ML system 400 is sometimes referred to as a ML module.

The ML system 400 includes a feature extraction module 408 implemented using components of the example computer system 400 illustrated and described in more detail with reference to FIG. 4. In some embodiments, the feature extraction module 408 extracts a feature vector 412 from input data 404. For example, the input data 404 can include one or more images, sets of text, audio files, or video files. The feature vector 412 includes features 412a, 412b, . . . 412n. The feature extraction module 408 reduces the redundancy in the input data 404, e.g., repetitive data values, to transform the input data 404 into the reduced set of features 412, e.g., features 412a, 412b, . . . 412n. The feature vector 412 contains the relevant information from the input data 404, such that events or data value thresholds of interest can be identified by the ML model 416 by using this reduced representation. In some example embodiments, dimensionality reduction techniques, such as principal component analysis (PCA) or autoencoders are used by the feature extraction module 408.

In alternate embodiments, the ML model 416 performs deep learning (also known as deep structured learning or hierarchical learning) directly on the input data 404 to learn data representations, as opposed to using task-specific algorithms. In deep learning, no explicit feature extraction is performed; the features 412 are implicitly extracted by the ML system 400. For example, the ML model 416 can use a cascade of multiple layers of nonlinear processing units for implicit feature extraction and transformation. Each successive layer uses the output from the previous layer as input. The ML model 416 can learn in supervised (e.g., classification) and/or unsupervised (e.g., pattern analysis) modes. The ML model 416 can learn multiple levels of representations that correspond to different levels of abstraction, wherein the different levels form a hierarchy of concepts. In this manner, the ML model 416 can be configured to differentiate features of interest from background features.

In alternative example embodiments, the ML model 416, e.g., in the form of a CNN generates the output 424, without the need for feature extraction, directly from the input data 404. The output 424 is provided to the computer device 428. The computer device 428 is a server, computer, tablet, smartphone, smart speaker, etc., implemented using components of the example computer system 300 illustrated and described in more detail with reference to FIG. 3. In some embodiments, the steps performed by the ML system 400 are stored in memory on the computer device 428 for execution. In other embodiments, the output 424 is displayed on high-definition monitors.

A CNN is a type of feed-forward artificial neural network in which the connectivity pattern between its neurons is inspired by the organization of a visual cortex. Individual cortical neurons respond to stimuli in a restricted region of space known as the receptive field. The receptive fields of different neurons partially overlap such that they tile the visual field. The response of an individual neuron to stimuli within its receptive field can be approximated mathematically by a convolution operation. CNNs are based on biological processes and are variations of multilayer perceptrons designed to use minimal amounts of preprocessing.

The ML model 416 can be a CNN that includes both convolutional layers and max pooling layers. The architecture of the ML model 416 can be “fully convolutional,” which means that variable sized sensor data vectors can be fed into it. For all convolutional layers, the ML model 416 can specify a kernel size, a stride of the convolution, and an amount of zero padding applied to the input of that layer. For the pooling layers, the ML model 416 can specify the kernel size and stride of the pooling.

In some embodiments, the ML system 400 trains the ML model 416, based on the training data 420, to correlate the feature vector 412 to expected outputs in the training data 420. As part of the training of the ML model 416, the ML system 400 forms a training set of features and training labels by identifying a positive training set of features that have been determined to have a desired property in question and a negative training set of features that lack the property in question. The ML system 400 applies ML techniques to train the ML model 416, that when applied to the feature vector 412, outputs indications of whether the feature vector 412 has an associated desired property or properties.

The ML system 400 can use supervised ML to train the ML model 316, with features from the training sets serving as the inputs. In some embodiments, different ML techniques, such as support vector machine (SVM), regression, naïve Bayes, random forests, neural networks, etc., are used. In some example embodiments, a validation set 432 is formed of additional features, other than those in the training data 420, which have already been determined to have or to lack the property in question. The ML system 400 applies the trained ML model 416 to the features of the validation set 432 to quantify the accuracy of the ML model 416. In some embodiments, the ML system 400 iteratively re-trains the ML model 416 until the occurrence of a stopping condition, such as the accuracy measurement indication that the ML model 416 is sufficiently accurate, or a number of training rounds having taken place.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt, which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, inputs to an LLM are structured prompt engineering. Prompt engineering is a process of structuring text that is able to be interpreted by a generative AI model. Predefined prompts, in some embodiments, serve as predefined templates or structured queries that already adhere to the expected format and content guidelines of specific AI models. For example, in some embodiments, a prompt (e.g., command set) includes the following elements: instruction, context, input data, and an output specification.

Although a prompt is a natural-language entity, a number of prompt engineering strategies help structure the prompt in a way that improves the quality of output. For example, in the prompt “Please generate an image of a bear on a bicycle for a children's book illustration,” “generate,” is the instruction, “for a children's book illustration” is the context, “bears on a bicycle” is the input data, and “an image” is the output specification. The techniques include being precise, specifying context, specifying output parameters, specifying target knowledge domain, and so forth.

Automatic prompt engineering techniques have the ability to, for example, include using a trained LLM to generate a plurality of candidate prompts, automatically score the candidates, and select the top candidates.

In some embodiments, prompt engineering includes the automation of a target process—for instance, a prompt causes an AI model to generate computer code, call functions in an API, and so forth. Additionally, in some embodiments, prompt engineering includes automation of the prompt engineering process itself—for example, an automatically generated sequence of cascading prompts, in some embodiments, include sequences of prompts that use tokens from AI model outputs as further instructions, context, inputs, or output specifications for downstream AI models. In some embodiments, prompt engineering includes training techniques for LLMs that generate prompts (e.g., chain-of-thought prompting) and improve cost control (e.g., dynamically setting stop sequences to manage the number of automatically generated candidate prompts, dynamically tuning parameters of prompt generation models or downstream models).

In some embodiments, the llama2 is used as a large language model, which is a large language model based on an encoder-decoder architecture, and can simultaneously perform text generation and text understanding. The llama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as a large language model, which is an autoregressive model trained on a large text corpus unsupervised.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

1. A system for revision of generative artificial intelligence (AI) model operators using domain specific command set modification connected to independent AI models, comprising:
a user interface that is communicatively connected to a general-purpose AI, the user interface including a command set prompt, wherein the general-purpose AI includes a training regimen that causes the general-purpose AI to respond to command sets by predicting next characters that conform to a command set; and
a domain-specific AI that receives data entered into the command set prompt and an output of the general-purpose AI, wherein the domain-specific AI includes a training regimen that causes the domain-specific AI to generate output within a limited purpose framework, the limited purpose framework including revision of the command set based on a predetermined domain of subject matter,
wherein the user interface is configured to transmit data from the command set prompt to the domain-specific AI and the domain-specific AI is configured to generate revised command set data that is executed on by the general-purpose AI.

2. The system of claim 1, wherein the domain-specific AI is further configured to revise output of the general-purpose AI within the predetermined domain of subject matter.

3. The system of claim 2, wherein the predetermined domain of subject matter is music playlists, the system further comprising:
a media player communicatively connected to the user interface and configured to return a plurality of audio files found on a text-music playlist and execute on those audio files; and
wherein the command set requests generation of a musical playlist and the domain-specific AI revise the command set to include additional parameters within the command set.

4. The system of claim 1, wherein the training regimen of the domain-specific AI further includes user-specific data of a first user.

5. The system of claim 4, wherein the user-specific data includes a play history of music associated with the first user.

6. The system of claim 1, wherein the training regimen of the domain-specific AI further includes a user-informed feedback loop.

7. The system of claim 1, wherein the general-purpose AI includes a propensity to respond to command sets that refer to the predetermined domain of subject matter with a predetermined class of output and revision of command set prompts by the domain-specific AI is configured to correct the propensity.

8. A method for revision of generative artificial intelligence (AI) model operators using domain specific command set modification connected to independent AI models, comprising:
receiving, by a user interface that is communicatively connected to a general-purpose AI, a command set, wherein the general-purpose AI includes a training regimen that causes the general-purpose AI to respond to command sets by predicting next characters that conform to the command set;
providing, the command set to a domain-specific AI, wherein the domain-specific AI includes a training regimen that causes the domain-specific AI to generate output within a limited purpose framework, the limited purpose framework including revision of command sets based on a predetermined domain of subject matter;
revising, by the domain-specific AI, the command set based on the predetermined domain of subject matter; and
providing the revised command set to the general-purpose AI for execution.

9. The method of claim 8, further comprising:
receiving, by the domain-specific AI, output of the general-purpose AI; and
revising, by the domain-specific AI, the output within the predetermined domain of subject matter.

10. The method of claim 9, wherein the predetermined domain of subject matter is music playlists, wherein the command set requests generation of a musical playlist and the domain-specific AI revise the command set to include additional parameters within the command set, the method further comprising:
requesting, from a media player, a plurality of audio files corresponding to songs included on a text-music playlist output by either of the general-purpose AI or the domain-specific AI; and
executing, by the media player, the plurality of audio files found on a text-music playlist.

11. The method of claim 8, wherein the training regimen of the domain-specific AI further includes user-specific data of a first user.

12. The method of claim 11, wherein the user-specific data includes a play history of music associated with the first user.

13. The method of claim 8, further comprising:
training the domain-specific AI via a user-informed feedback loop.

14. The method of claim 8, wherein the general-purpose AI includes a propensity to respond to command sets that refer to the predetermined domain of subject matter with a predetermined class of output and revision of command set prompts by the domain-specific AI is configured to correct the propensity.

15. A method for revision of generative artificial intelligence (AI) model operators using domain specific command set modification connected to independent AI models, comprising:
receiving, by a user interface that is communicatively connected to a general-purpose AI, a command set that requests generation of a musical playlist, wherein the general-purpose AI includes a training regimen that causes the general-purpose AI to respond to command sets by predicting next characters that conform to the command set;
providing, the command set to a domain-specific AI, wherein the domain-specific AI includes a training regimen that causes the domain-specific AI to generate output within a limited purpose framework, the limited purpose framework including revision of command sets based on a predetermined domain of subject matter connected to musical playlist requests;
revising, by the domain-specific AI, the command set based on the predetermined domain of subject matter wherein revision of the command set to includes incorporating additional parameters within the command set; and
providing the revised command set to the general-purpose AI for execution.

16. The method of claim 15, further comprising:
receiving, by the domain-specific AI, output of the general-purpose AI; and
revising, by the domain-specific AI, the output within the predetermined domain of subject matter.

17. The method of claim 15, further comprising:
requesting, from a media player, a plurality of audio files corresponding to songs included on a text-music playlist output by either of the general-purpose AI or the domain-specific AI; and
executing, by the media player, the plurality of audio files found on a text-music playlist.

18. The method of claim 15, wherein the training regimen of the domain-specific AI further includes user specific data of a first user including a play history of music associated with the first user.

19. The method of claim 15, further comprising:
training the domain-specific AI via a user-informed feedback loop.

20. The method of claim 15, wherein the general-purpose AI includes a propensity to respond to command sets that requesting musical playlists with repeat songs within the output and revision of command set by the domain-specific AI is configured to replace repeats.
